(19) United States
(12) Patent Application Publication
(10) Pub. No.: US 2022/0404806 A1
(43) Pub. Date: Dec. 22, 2022

(54) METHOD FOR ASSISTING WITH THE POSITIONING OF A DRILL BIT FOR BORING A COMPONENT

(71) Applicant: Airbus Operations SAS, TOULOUSE (FR)

(72) Inventors: Julien BIGOT, TOULOUSE (FR); Charly FOISSAC, TOULOUSE (FR); Guillaume PICHON, TOULOUSE (FR)

(21) Appl. No.: 17/841,125

(22) Filed: Jun. 15, 2022

(30) Foreign Application Priority Data
Jun. 17, 2021 (FR) 2106404

(51) Int. Cl. G05B 19/418; B23Q 3/16

(52) U.S. Cl. CPC G05B 19/41825; G05B 19/4183; B23Q 3/16

(57) ABSTRACT

A method for assisting with the positioning of a drill bit for boring a component, which includes capturing images of a first component which has notable points, of calculating a digital representation from these images, of superposing the digital representation thus calculated and a digital design representation of the component, of evaluating the distances of the centers of bores to be created with respect to the notable points, and of positioning a drill bit with the aid of a camera and of the evaluated distances. The method continues in the same way for the other components to be assembled.

### CROSS-REFERENCES TO RELATED APPLICATIONS

This application claims the benefit of the French patent application No. 2106404 filed on Jun. 17, 2021, the entire disclosures of which are incorporated herein by way of reference.

### FIELD OF THE INVENTION

The present invention relates to a method for assisting with the positioning of a drill bit for boring a component and potentially a plurality of components for the assembly thereof

### BACKGROUND OF THE INVENTION

In industry, in particular in the aeronautical industry, it is often necessary to create bores in a component. To this end, it is known to position the component on a machine tool bearing a drill bit, and to program the machine tool such that the drill bit and/or the plate is/are moved so as to align the drill bit with the position at which the bore needs to be created.

In spite of all the care taken during the positioning of the components, the positioning of the bore may be slightly different from what is expected. Such a difference may be due, for example, to the tolerances of the machine tool, a slight discrepancy in the positioning of the component, etc.

In other words, the position of each bore is determined with respect to the reference frame of the machine tool, and incorrect positioning of the component or the tolerances of the machine tool have an impact on the position of the bores.

In particular, when a component has a large size, a slight discrepancy in the positioning of the component or in the movement of the drill bit may have significant consequences on account of the great length of the component.

Moreover, when it is necessary to fix two components together, the above method is carried out for each component and the discrepancies are copied over to each component and add up, making assembly difficult.

### SUMMARY OF THE INVENTION

It is an object of the present invention to propose a method for assisting with the positioning of a drill bit for boring a component, and potentially a plurality of components for the purpose of assembling them.

To this end, there is a proposed a method for assisting with the positioning of a drill bit for boring a component, carried out with the aid of a machine tool having a control unit, a drill head bearing the drill bit and at least one optical sensor secured to the drill head, wherein the method involves:

for a first component,
a first capturing step, during which the, or each, optical sensor captures at least one image of the first component including the face to be drilled on which at least two notable points are identified,
a first digitization step, during which the control unit calculates a digital representation of the first component from the or each image thus captured,
a first superposition step, during which the control unit digitally superposes the digital representation thus calculated and a digital design representation of the first component including the centers of the bores to be created,
a first evaluation step, during which the control unit evaluates the distance of each center from a plurality of notable points on the face of the first component,
a first positioning step, during which, on the basis of the images of the face of the first component transmitted live by the or each optical sensor and of the distances thus evaluated, the control unit orders the drill head to move until it is vertically in line with the center of each bore to be created in the first component and orders the drilling of the first component by the drill bit.

With such a method, the component is drilled precisely on the basis of a triangulation with respect to notable points on the components and not with respect to the machine tool.

Advantageously, before the first capturing step, the method involves a uniqueness step, during which the face of the first component to be drilled is rendered unique by putting notable points on the face.

Advantageously, there is at least one additional component, and the method involves:
a second capturing step, during which the or each optical sensor captures at least one image of the first component including the drilled face,
a second digitization step, during which the control unit calculates a digital representation of the first component from the or each image thus captured,

and, for each additional component,
a third capturing step, during which the or each optical sensor captures at least one image of the additional component including the face to be drilled, on which at least two notable points are identified,
a third digitization step, during which the control unit calculates a digital representation of the additional component from the or each image thus captured,
a second superposition step, during which the control unit digitally superposes the digital representation of the first drilled component and the digital representation of the additional component thus calculated,
a second evaluation step, during which the control unit evaluates the distance of each center from a plurality of notable points on the face of the additional component, and
a second positioning step, during which, on the basis of the images of the face of the additional component transmitted live by the or each optical sensor and of the distances thus evaluated, the control unit orders the drill head to move until it is vertically in line with the center of each bore to be created in the additional component and orders the drilling of the additional component by the drill bit.

Advantageously, before the third capturing step, the method involves a uniqueness step, during which the face of each additional component to be drilled is rendered unique by putting notable points on the face.

### BRIEF DESCRIPTION OF THE DRAWINGS

The features of the invention that are mentioned above, and others, will become more clearly apparent from reading the following description of an exemplary embodiment, the description being given in relation to the appended drawings, in which:

FIG. 1 is a view in cross section of an example of the assembly of three components having bores created using the method according to the invention,

FIG. 2 is an image of a top view of a front component before it is drilled,

FIG. 3 is a schematic depiction of a material architecture of a control unit of a machine tool used in the scope of the method according to the invention, and

FIG. 4 is a flow chart of the method according to the invention.

### DETAILED DESCRIPTION OF THE PREFERRED EMBODIMENTS

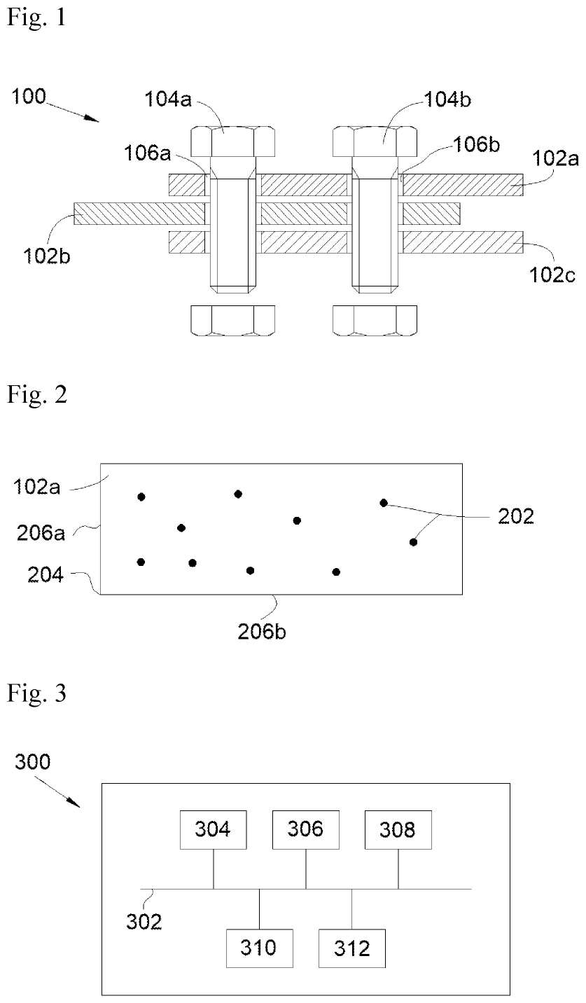

FIG. 1 shows an assembly 100 created from three components 102a-c fixed together by two bolts 104a-c. For this purpose, each component 102a-c is drilled with two bores 106a-b.

Although the following description is oriented more particularly toward the case of an assembly of several components 102a-c, the method according to the invention that is described below may be used first and foremost in the case of the drilling of a single component 102a and optionally in the case of the drilling of several components 102a-c for the purpose of assembling them.

The general principle of the invention comprises using at least one optical sensor, for example a camera, in order to capture at least one image of the or each component including the face to be drilled, to construct a digital representation of the or each component, to identify the notable points thereon, and, on the basis of these notable points, the machine tool calculates the appropriate position at which the machine tool needs to position the drill bit. The aim is to create bores 106a-b, for example for the fitting of the bolts 104a-b, on the basis of a reference frame associated with the component 102a-c and not on the basis of a reference frame associated with the machine tool.

As the case may be, it may be sufficient to have a digital representation of the entire component or only of the surface to be drilled, for example when the component is only a flat panel. Thus, as the case may be, the use of a single optical sensor capturing a single image may be sufficient, in combination with a method for contour detection for example in order to obtain a two-dimensional digital representation of the surface to be drilled. However, it may be necessary to use several optical sensors, each capturing at least one image, and then to use a method for example of the stereo-correlation type in order to obtain a three-dimensional (3D) digital representation of the component.

FIG. 2 shows an image of a first component 102a which has a plurality of notable points 202 on the face of the first component 102a that needs to be bored. These notable points 202 are, for example, distinctive elements of the component, for example bores that are already present, corners of the component, etc., but, according to one particular embodiment, these notable points are points added to the face of the first component 102a. According to one particular embodiment, these notable points 202 are for example sprayed points of paint created to this end by any appropriate paint spraying system. According to another particular embodiment, a sheet, for example a self-adhesive sheet, on which these notable points 202 are printed is stuck to the face to be bored.

The machine tool has a drill head bearing a drill bit and movement means which make it possible to move the drill head in the entire space covered by the machine tool. Each movement means is for example a motor-driven slide system. The machine tool also has a motor driving the drill bit in rotation.

The machine tool also has at least one optical sensor secured to the drill head in order to obtain a two-dimensional digital representation of the component or at least two optical sensors in order to obtain a two-dimensional digital representation of the component.

The machine tool also has a control unit which controls each movement means, the or each optical sensor and the drill bit motor, and a schematic depiction of which is shown in FIG. 3.

The control unit 300 has, connected by a communication bus 302: a processor 304 or CPU (“Central Processing Unit”); a RAM 306 (“Random Access Memory”); a ROM 308 (“Read Only Memory”); a storage unit 310 such as a hard disk or a storage medium reader, such as an SD (“Secure Digital”) card reader; at least one communication interface 312, allowing, for example, the processing unit to communicate with the movement means, the or each optical sensor, the motor driving the drill bit in rotation, etc.

The processor is capable of executing instructions loaded into the RAM from the ROM, from an external memory (not shown), from a storage medium (such as an SD card), or from a communication network. When the machine tool is powered up, the processor is capable of reading instructions from the RAM and of executing them. These instructions form a computer program causing the processor to implement all or part of the algorithms and steps that are described below.

All or part of the algorithms and steps that are described below may be implemented in the form of software by the execution of a set of instructions by a programmable machine, for example a DSP (“Digital Signal Processor”) or a microprocessor, or may be implemented in the form of hardware by a machine or a dedicated component, for example an FPGA (“Field-Programmable Gate Array”) or an ASIC (“Application-Specific Integrated Circuit”).

With the aid of the or each optical sensor, at least one image of the first component 102a to be drilled including the face to be drilled on which notable points 202 are identified is captured and then saved in the storage unit 310. The presence of these notable points 202 which vary from one component 102a-c to another allows unique identification of each component 102a-c. The notable points 202 are identified for example by the control unit 300 through a difference in contrast between the notable points 202 and the first component 102a with the aid of appropriate image processing software.

On the basis of the or each image thus captured, the control unit 300 will calculate a digital representation of the first component 102a. This digital representation may be a two-dimensional digital representation or, as already explained, the capture of two images by different optical sensors makes it possible to use a stereo-correlation method to obtain a 3D digital representation of the first component 102a.

On the basis of the design data of the first component 102a that are received, for example from CAO software, and constitute a digital design representation, the control unit 300 digitally superposes the digital representation of the first component 102a calculated beforehand and the digital design representation of the first component 102a, including the centers of the bores 106a-b to be created.

Following superposition of the two digital representations, it is then possible to evaluate the position of each center of a bore 106a-b with respect to several of the notable points 202, thereby effecting a transfer of the centers of bores to the digital representation calculated.

On the basis of this superposition, the distances of the center of each bore 106a-b from a plurality of notable points 202 on the face of the first component 102a are evaluated by the control unit 300. The position of the center of each bore 106a-b is thus determined by triangulation with respect to the different notable points 202 on the face of the first component 102a. While the triangulation can be effected on the basis of two notable points 202, the greater the number of notable points 202, the greater the precision, and preference will be given to using as a basis an image in which the center of the bore 106a-b to be drilled is at the center of a plurality of notable points 202.

Each notable point 202 is conflated with its barycenter or is divided into a number of pixels and each pixel becomes a notable point 202.

On the basis of this determination of the position of the center of each bore 106a-b with respect to the notable points 202 and by analysis of the image of the face of the first component 102a captured live by the or each optical sensor, the control unit 300 then orders the drill head to move, by actions on the movement means, so as to position the drill bit vertically in line with the center of each bore 106a-b to be created. By virtue of each image received live by the control unit 300 during the movement of the drill head, the control unit 300 detects the notable points 202 used for the triangulation, and determines the position of the center from these different notable points 202 on the face of the first component 102a and the previously calculated distances. Each bore 106a-b is then created in the first component 102a.

The identification of the position to be reached comprises, for example, finding the image of the notable points 202 surrounding the center of the bore to be drilled in the first component 102a, for example using the Haar cascade method.

The position of the center of the bore 106a-b is therefore evaluated on the basis of the physical data of the first component 102a and no longer on the basis of the intrinsic data of the machine tool, giving rise to greater precision.

When it is envisaged to assembly several components together, it is desirable to align the bores of the different components 102a-c to allow easy assembly.

Once the bores 106a-b have been created in the first component 102a, a new image of the first component 102a including the face drilled with the bores 106a-b is captured by the or each optical sensor and saved in the storage unit 310. Then, the control unit calculates a new digital representation of the first component 102a from the or each image thus captured.

For a second component 102b, a similar process is carried out with, in the same way, notable points 202 arranged on the face of the second component 102b that needs to be drilled. At least one image of the additional component 102b including this face to be drilled is captured by the or each optical sensor and saved in the storage unit 310. As in the case of the first component 102a, a digital representation of the additional component 102b is calculated from the or each image thus captured.

The digital representation of the drilled first component 102a and the digital representation of the additional component 102b are then superposed in the position that the two components 102a-b need to take up in the assembly 100, making it possible to place the bores in the first component 102a on the image of the face of the second component 102b and thus to align the different bores 106a-b for the purpose of assembly.

On the basis of this superposition and in a similar way to before, the distance of the center of each bore 106a-b in the second component 102b with respect to each notable point 202 on the face of the second component 102b is evaluated by the control unit 300.

As before, with the aid of the or each optical sensor, the control unit 300 determines the position of the center of each bore 106a-b to be created in the second component 102b from the different notable points 202 on the second component 102b that arise from the images captured live. Then, each bore 106a-b is created in the second component 102b.

The same process is repeated for each complementary component 102c to be assembled.

Such a process is therefore relatively simple to implement and the use of a plurality of points for the triangulation and positioning of the drill head makes it possible to achieve a high level of precision.

Moreover, all the data thus collected about the different components are stored and can be retrieved if necessary, for example in the case of maintenance or replacement of a component.

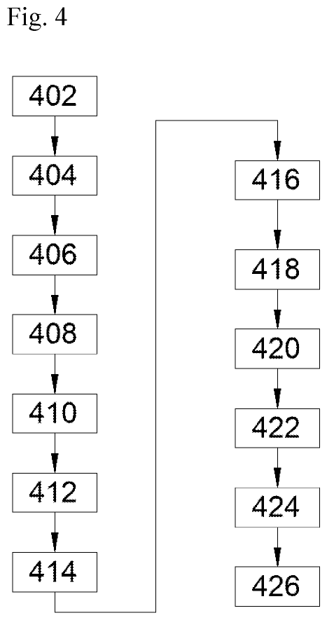

FIG. 4 shows a flow chart of the method for assisting with the positioning of the drill bit for boring a component 102a according to the invention. The method involves:

for the first component 102a,
a first capturing step 404, during which the or each optical sensor captures at least one image of the first component 102a including the face to be drilled on which at least two notable points 202 are identified,
a first digitization step 406, during which the control unit 300 calculates a digital representation of the first component 102a from the or each image thus captured,
a first superposition step 408, during which the control unit 300 digitally superposes the digital representation thus calculated and a digital design representation of the first component 102a including the centers of the bores 106a-b to be created,
a first evaluation step 410, during which the control unit 300 evaluates the distance of each center from a plurality of notable points 202 on the face of the first component 102a,
a first positioning step 412, during which, on the basis of the images of the face of the first component 102a transmitted live by the or each optical sensor and of the distances thus evaluated, the control unit 300 orders the drill head to move until it is vertically in line with the center of each bore 106a-b to be created in the first component 102a and orders the drilling of the first component 102a by the drill bit.

When there is at least one additional component 102b-c, the method also involves:

for the first component 102a, after the first positioning step 412,
a second capturing step 414, during which the or each optical sensor captures at least one image of the first component 102a including the drilled face,

and, for each additional component 102b-c,
a third capturing step 418, during which the or each optical sensor captures at least one image of the additional component 102b-c including the face to be drilled, on which at least two notable points 202 are identified,
a third digitization step 420, during which the control unit 300 calculates a digital representation of the additional component 102b-c from the or each image thus captured,
a second superposition step 422, during which the control unit 300 digitally superposes the digital representation of the first drilled component 102a and the digital representation of the additional component 102b-c thus calculated,
a second evaluation step 424, during which the control unit 300 evaluates the distance of each center from a plurality of notable points 202 on the face of the additional component 102b-c, and
a second positioning step 426, during which, on the basis of the images of the face of the additional component 102b-c transmitted live by the or each optical sensor and of the distances thus evaluated, the control unit 300 orders the drill head to move until it is vertically in line with the center of each bore 106a-b to be created in the additional component 102b-c and orders the drilling of the additional component 102b-c by the drill bit.

From the second positioning step 426, the process loops to the third capturing step 418 for each additional component 102b-c.

As explained above, the notable points 202 may be features of the component 102a-c or points added to the face of the component 102a-c either by the deposition of points of paint or by the placement of a printed sheet.

When there is a single component 102a to be drilled, the method then involves, before the first capturing step 404, a uniqueness step 402, during which the face of the first component 102a to be drilled which is seen by the or each optical sensor is rendered unique by putting notable points 202 on the face.

In the case of an assembly 100, the method then involves, before the third capturing step 418, a uniqueness step 402, during which the face of each additional component 102b-c to be drilled which is seen by the or each optical sensor is rendered unique by putting notable points 202 on the face.

In the embodiment of the invention presented in FIG. 4, the two uniqueness steps are combined in a common step.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for assisting with the positioning of a drill bit for boring a component, carried out with a machine tool having a control unit, a drill head bearing the drill bit and at least one optical sensor secured to the drill head, wherein said method comprises:
for a first component,
capturing in a first capturing step, during which said or each optical sensor captures at least one image of the first component including a face to be drilled on which at least two notable points are identified,
digitizing in a first digitization step, during which the control unit calculates a digital representation of the first component from the or each image thus captured,
superimposing in a first superposition step, during which the control unit digitally superposes the digital representation thus calculated and a digital design representation of the first component including centers of bores to be created,
evaluating in a first evaluation step, during which the control unit evaluates a distance of each center from a plurality of notable points on the face of the first component, and
positioning in a first positioning step, during which, based on the images of the face of the first component transmitted live by the or each optical sensor and of the distances thus evaluated, the control unit orders the drill head to move until it is vertically in line with the center of each bore to be created in the first component and orders the drilling of the first component by the drill bit.

2. The method for assisting with the positioning according to claim 1, wherein, before the first capturing step, said method involves a marking in a uniqueness step, during which the face of the first component to be drilled is rendered unique by putting notable points on said face.

3. The method for assisting with positioning according to claim 1, wherein there is at least one additional component, and wherein the method involves:
for the first component, after the first positioning step,
capturing in a second capturing step, during which said or each optical sensor captures at least one image of the first component including the drilled face,
digitizing in a second digitization step, during which the control unit calculates a digital representation of the first component from the or each image thus captured, and
for each additional component,
capturing in a third capturing step, during which said or each optical sensor captures at least one image of the additional component including the face to be drilled, on which at least two notable points are identified,
digitizing in a third digitization step, during which the control unit calculates a digital representation of the additional component from the or each image thus captured,
superimposing in a second superposition step, during which the control unit digitally superposes the digital representation of the first drilled component and the digital representation of the additional component thus calculated,
evaluating in a second evaluation step, during which the control unit evaluates a distance of each center from a plurality of notable points on the face of the additional component, and
positioning in a second positioning step, during which, based on the images of the face of the additional component transmitted live by the or each optical sensor and of the distances thus evaluated, the control unit orders the drill head to move until it is vertically in line with the center of each bore to be created in the additional component and orders the drilling of the additional component by the drill bit.

4. The method for assisting with the positioning according to claim 3, wherein, before the third capturing step, said method involves marking in a uniqueness step, during which the face of each additional component to be drilled is rendered unique by putting notable points on said face.
